(19) United States
(12) Patent Application Publication
(10) Pub. No.: US 2023/0211418 A1
(43) Pub. Date: Jul. 6, 2023

(54) METHOD FOR PRODUCING AN IMPACT-RESISTANT COMPONENT, AND CORRESPONDING IMPACT-RESISTANT COMPONENT

(71) Applicant: MTU Aero Engines AG, Munich (DE)

(72) Inventor: Martin SCHLOFFER, Paehl (DE)

(21) Appl. No.: 18/056,353

(22) Filed: Nov. 17, 2022

(30) Foreign Application Priority Data
Nov. 26, 2021 (DE) 102021131094.6

(51) Int. Cl. B22F 10/28; B22F 3/24; C22C 14/00; C22C 21/00; B22F 10/36; B22F 10/32; B22F 10/38

(52) U.S. Cl. CPC B22F 10/28; B22F 3/24; C22C 14/00; C22C 21/00; B22F 10/36; B22F 10/32; B22F 10/38; B33Y 70/10

(57) ABSTRACT

A method for producing an impact-resistant component, in particular a component of a turbomachine, such as an aircraft engine, and a corresponding component. The component is produced at least partially by an additive manufacturing method from a powder material in such a way that the component is formed at least in a first region from a material with a first toughness and at least in a second region from a material with a second toughness, the second toughness being greater than the first toughness, and wherein the second region is formed, at least in a part of the component, as a continuous or interrupted layer, preferably parallel to the surface of the component, at a distance from the surface of the component.

### CROSS-REFERENCE TO RELATED APPLICATIONS

The present application claims priority under 35 U.S.C. § 119 of German Patent Application No. 102021131094.6, filed Nov. 26, 2021, the entire disclosure of which is expressly incorporated by reference herein.

### BACKGROUND OF THE INVENTION

### 1. Field of the Invention

The present invention relates to a method for producing an impact-resistant component, in particular a component of a turbomachine, such as an aircraft engine, wherein the component is produced at least partially from a powder material by an additive manufacturing method. The invention furthermore relates to a corresponding impact-resistant component, in particular a component of a turbomachine or a component of an aircraft engine.

### 2. Discussion of Background Information

In turbomachines, such as gas turbines or aircraft engines, components are used which must meet high requirements in respect of their strength, high-temperature resistance, corrosion resistance, etc. Particularly in the case of guide vanes or rotor blades of aircraft engines, a certain impact resistance must also be ensured, since, in the case of shock loads, such as the impact of foreign bodies, damage or failure of the corresponding component must be avoided. Moreover, such components must have as low a weight as possible, particularly in aircraft engines, in order to allow efficient turbine performance. In addition, the components should be as simple as possible to produce or a corresponding material for said components should be easy to process.

One possible material for use in guide vanes or rotor blades of turbomachines comprises the intermetallic TiAl alloys, which have a low relative density and, owing to the intermetallic phases, such as γ-TiAl and α₂-Ti₃Al, have a high strength in their microstructure. By powder-metallurgical processing or generative production processes, components made of these alloys can also be produced with a manageable outlay, as has already been described, for example, in US 2019/0299288 A1, the entire disclosure of which is incorporated by reference herein. However, the impact resistance of these materials or components produced therefrom is in need of improvement since the high-strength intermetallic phases tend to have a brittle fracture behavior. US 2019/0299288 A1 has likewise described the fact that regions with different material composition and correspondingly different properties, such as increased strength or ductility, can be produced in the generative production of, for example, rotor blades of aircraft engines, but there is still a need to improve impact resistance in particular.

In view of the foregoing, it would be advantageous to be able to provide a method for producing an impact-resistant component, in particular for a turbomachine, such as an aircraft engine, and a corresponding component, such as a guide vane or rotor blade of an aircraft engine, so that even less tough materials, such as intermetallic TiAl alloys, can be used for corresponding components, and the corresponding components nevertheless have sufficient toughness and, in particular, impact resistance. In particular, such components should be simple to produce and reliable in use.

### SUMMARY OF THE INVENTION

The present invention proposes using a generative method for producing an impact-resistant component, wherein the component is produced at least partially by the additive manufacturing method from a powder material, thus enabling the component to be built up in a simple manner in such a way that the component has at least one first region of a material with a first toughness and at least one second region of a material with a second toughness, wherein the second toughness is greater than the first toughness. As a result, by assigning different properties to different regions of the component, the component can have a balanced property profile and, in particular, can also have sufficient toughness. According to the invention, this is achieved, in particular, by virtue of the fact that the second region is formed, at least in a part of the component, as a continuous or interrupted layer, preferably parallel to the surface of the component, at a distance from the surface of the component. As a result of the arrangement in the interior of the component, the tough layer of increased toughness is protected against environmental influences but, after the initiation of a crack from the surface of the component, can prevent the further propagation of the crack into the interior of the component sufficiently quickly. For this purpose, it is sufficient to provide the tougher material merely in the form of a layer, which therefore has a significantly greater extent in the transverse and longitudinal directions than the thickness direction if the transverse, longitudinal and thickness directions are regarded as independent spatial directions matched to the alignment of the layer. In particular, the layer can be designed as a thin layer in which the thickness of the layer is less than about 30%, in particular less than about 10%, of the maximum length or width. Accordingly, the overall strength of the component is also not noticeably reduced.

In additive manufacturing, the component can be built up in strata from powder material on a substrate or a previously produced part of the component and joined to form a solid component, wherein the method can be selected, in particular, from a group which comprises selective laser melting, selective electron beam melting, selective laser sintering, selective electron beam sintering and powder deposition welding.

In a section through the component, in particular perpendicularly to a build-up direction, the layer can have a closed annular profile and/or can run as a continuous line or as a broken line at a distance from the surface of the component.

The toughness of a material adjoining the layer on both or on a plurality of sides is, in particular, less than the second toughness and, in particular, can correspond to the first toughness.

In a section through the component, in particular perpendicularly to a build-up direction, a section line of the layer or the profile of the cross section through the layer can separate two material regions of lower toughness, in particular the first toughness, from one another and can have a toothed profile which interlocks the separated regions positively, in particular in all directions parallel to the section.

The material with the second or increased toughness can be produced by means of a different additive deposition process from the material with the first, lower toughness, in particular by means of additive deposition with one or more different deposition parameters, thus enabling the same starting material to be used. As an alternative, it is also possible to use a different powder material for the tough layer.

The different deposition parameter or parameters during the additive deposition process can involve different melting or sintering temperatures and/or different holding times in the molten state or in the heated state and/or different ambient pressures, wherein the different deposition conditions are intended to lead quite generally to different chemical compositions and/or different structure formations in the respective regions.

In particular, the different deposition parameters of the powder material can be selected in such a way that different amounts of constituents of the powder material evaporate, thereby enabling a different chemical composition of the tough layer from the other regions of the component to be set. In the case of TiAl alloys, increased evaporation of aluminum can lead to a reduction in the aluminum content up to the formation of a Ti alloy, and it is possible, by means of Ti-richer phases, to achieve increased ductility of the material.

As an alternative or in addition to different deposition conditions during additive manufacture, the increased toughness of the tough layer can be produced by aftertreatment during additive deposition, that is to say in particular after the deposition of each stratum or of a plurality of strata. For the aftertreatment, a high-energy beam, such as a laser beam or electron beam, can be used, and this is preferably also used for additive production.

The tough layer can be produced, in particular, in that, after the additive deposition of a stratum, the relevant stratum or a plurality of successive strata together is treated again along a line contour with the high-energy beam or by multiple overscanning in some region or regions to form a stratum of the layer. It is thereby possible to produce tougher lateral surfaces, lattice and/or mesh structures within the component.

The aftertreatment can be accomplished by reheating or remelting at least part of an already additively deposited stratum of the component, preferably in a width of from about 100 μm to abpit 2000 μm, in particular of from about 200 μm to about 1500 μm, and/or a depth of at least one stratum thickness, it being possible, in particular, for certain constituents of the material, e.g. aluminum in the case of TiAl alloys, to be evaporated in the region of the tough layer to be formed.

For the production of impact-resistant components composed predominantly of TiAl alloys, a powder of a TiAl alloy and/or a mixture of powders of the individual elements for forming a TiAl alloy can be used as the powder material for additive deposition. In particular, a TiAl alloy can be used which comprises from about 43.5 at. % to about 48 at. % Al, from about 4 at. % to about 6 at. % Nb and, of the alloying elements Mo, W, Zr, Si, C and B in total up to about 2 at. %, the remainder being Ti and unavoidable impurities. Preferably, an alloy comprising about 43.5 at. % Al, about 4 at. % Nb, about 1 at. % Mo and about 0.1 at. % boron, the remainder being Ti and unavoidable impurities, or an adapted alloy which, after production, has the abovementioned composition, are used since such an alloy has an advantageous property profile.

After additive manufacture, the component can be subjected to a heat treatment in order to optimize the structure formation in order to adjust the structures of the material with the first toughness and of the material with the second toughness.

Accordingly, according to a further aspect of the invention, for which protection is sought independently of and in combination with other aspects of the invention, an impact-resistant component is proposed which can be produced, in particular, by an additive manufacturing method and preferably according to the preceding description, wherein the component has at least one first region of a material with a first toughness and at least one second region of a material with a second toughness, wherein the second toughness is greater than the first toughness. In this case, the second region of increased toughness is formed, at least in a part of the component, as a continuous or interrupted layer at a distance from the surface of the component.

The tough layer of increased toughness as compared with the rest of the component can run parallel to the surface of the component, at least in a part of the component, wherein the tough layer of increased toughness can be located from about 100 μm to about 1200 μm, in particular from about 200 μm to about 500 μm below the component surface. In this case, the tough layer of the material of increased toughness can have a layer thickness of from about 100 μm to about 2000 μm, in particular of from about 200 μm to about 1500 μm, extending in the direction perpendicular to the component surface.

Not only may the tough layer be a continuously formed layer, but the tough layer may also be interrupted and, in particular, may have a mesh or lattice structure.

The different toughness of the tough layer with respect to the remaining material of the component can be achieved by a different chemical composition of the materials and/or a different microstructure.

In the case of a component of a TiAl alloy, the TiAl alloy can comprise about 43.5 at. % Al, about 4 at. % Nb, about 1 at. % Mo and about 0.1 at. % boron, the remainder being Ti and unavoidable impurities. The material of the tough layer of increased toughness can be a material with a reduced aluminum content, in particular a Ti alloy containing from about 10 at. % to about 20 at. % Al, from about 5.7 at. % to about 6.4 at. % Nb, from about 1.4 at. % to about 1.6 at. % Mo and from about 0.1 at. % to about 0.2 at. % boron, the remainder being Ti and unavoidable impurities, preferably a Ti alloy comprising about 10 at. % Al, about 6.4 at. % Nb, about 1.6 at. % Mo and about 0.2 at. % boron, the remainder being Ti and unavoidable impurities.

Accordingly, the material with the first toughness can be built up with an intermetallic TiAl structure with γ-TiAl and α₂-Ti₃Al and the material with the second toughness can be built up with a microstructure of a Ti alloy based on an α phase, a β phase and/or an ω phase.

### BRIEF DESCRIPTION OF THE DRAWINGS

In the Attached Drawings, which are Purely Schematic,

FIG. 1 shows a schematic illustration of a device for the generative or additive production of components according to the invention using the example of selective electron beam melting,

FIG. 2 shows a perspective illustration of a first exemplary embodiment of a component according to the invention,

FIG. 3 shows an illustration of a blade produced according to the invention for an aircraft engine, and

FIG. 4 shows a cross section through a blade of an aircraft engine, which is produced in accordance with the method according to the invention.

### DETAILED DESCRIPTION OF EXEMPLARY EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show details of the present invention in more detail than is necessary for the fundamental understanding of the present invention, the description in combination with the drawings making apparent to those of skill in the art how the several forms of the present invention may be embodied in practice.

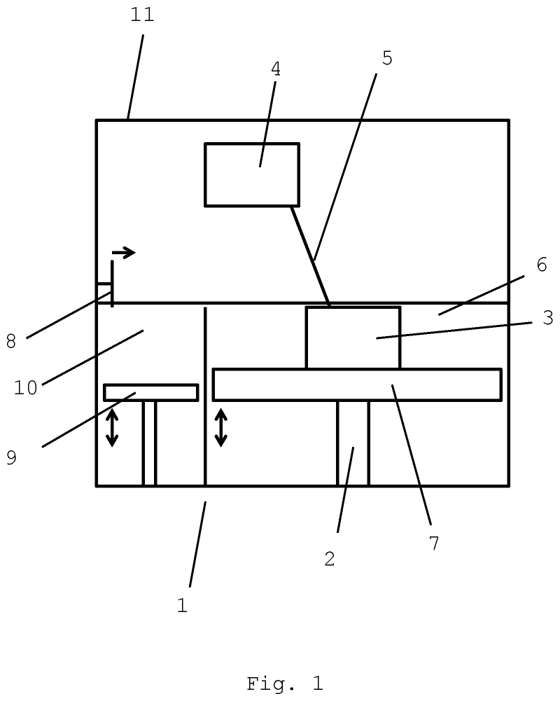

FIG. 1 shows, in a purely schematic illustration, a device 1 of the kind that can be used, for example, for selective electron beam melting for the generative production of a component and, in particular, of a guide vane or rotor blade of an aircraft engine. The device 1 comprises a lifting table 2, on whose platform 7 a semifinished product 3 is arranged, on which material is deposited in strata in order to produce a three-dimensional component in the form of a guide vane or rotor blade for a turbomachine. Instead of the semifinished product 3, it is also possible for a substrate to be provided on the platform 7 for the deposition of a first material stratum. In order to deposit a stratum, powder 10, which is located above a lifting table 9 in a powder supply, is pushed as a stratum over the semifinished product 3 by means of the slide 8 and is then melted by the electron beam 5 of an electron source 4, with the result that the powder particles can bond to one another and to the semifinished product 3 which is already present and, after solidification, form a material bond. The bonding of the powder material in a powder stratum to the semifinished product 3 by melting and resolidification is effected by the electron beam 5 as a function of the desired contour of the component to be produced, thus enabling any desired three-dimensional shapes to be produced. Correspondingly, the electron beam 5 is guided over the powder bed 6 in order to melt powder material in the powder stratum in accordance with the contour of the three-dimensional component in a sectional plane through the component to be produced by means of different impingement points on the powder bed and to bond it to the already produced part of a component or to an initially provided substrate. During this process, the electron beam 5 can be guided over the surface of the powder bed 6 by a suitable deflection unit, and/or the powder bed could be moved relative to the electron beam 5.

In order to avoid unwanted reactions with the ambient atmosphere during melting, the process can take place in a closed space which is provided by a housing 11 of the device 1 and, in addition, a vacuum atmosphere or inert gas atmosphere can be provided in order, for example, to avoid oxidation of the powder material and the like during the deposition of the individual strata. As an inert gas it is possible, for example, to use nitrogen, which is provided via a gas supply (not shown).

Instead of the inert gas, it would also be possible to use some other process gas if, for example, reactive deposition of the powder material is desired.

In addition, other high-energy types of radiation are also conceivable, such as, for example, laser beams or other particle beams or light beams which are used in stereolithography.

According to the invention, the impact-resistant component to be produced can be built up additively with at least one tough layer at a distance from the surface of the component, wherein the tough layer has a higher toughness than the remaining component volume, which can be achieved by a different material with a different chemical composition and/or by the formation of different structures. This can be achieved by different deposition parameters when carrying out the additive production process or by aftertreatment of a part of one or more deposited strata.

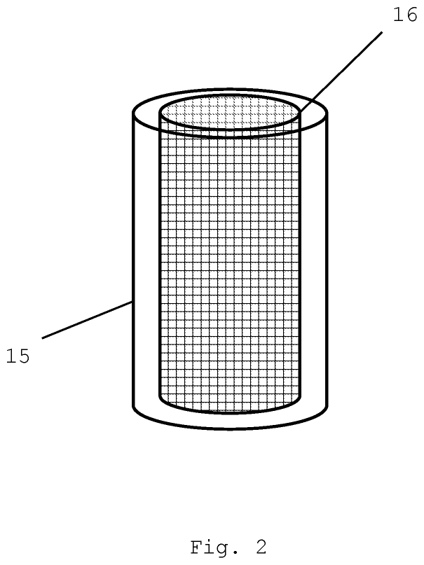

FIG. 2 shows a first exemplary embodiment of a component 15 according to the invention with a tough layer 16 which is at a distance from the component surface and which, in the exemplary embodiment shown in FIG. 2, is not designed as a continuous layer but as an interrupted layer in the form of a cylindrical-tube shaped lattice and is arranged at a distance from the lateral surface of the cylindrical component 15. The component 15 has the shape of a solid cylinder, in which the cylindrical-tube-shaped, tough layer is embedded as a lattice structure. In the case of deposition in strata along the longitudinal axis of the cylinder, circular segments of the horizontal lattice struts and/or subsections of the vertical lattice struts are generated in each of the individual strata in the circular cross section of the cylindrical-tube-shaped, tough layer 16 in accordance with the cross sectional plane of the cylindrical-tube-shaped lattice structure by appropriate deposition during the additive production process and/or by suitable aftertreatment of one or more last deposited strata, e.g. by remelting by means of the electron beam 5. Owing to the different deposition conditions and/or the aftertreatment, the cylindrical-tube-shaped, tough layer 16 thus produced with a lattice structure has a different chemical composition and/or a modified structure as compared with the remaining material of the component 15 and thus has a higher toughness than the remaining, surrounding material of the component 15 of lower toughness.

If the component 15 is formed, for example, from a TiAl alloy, in particular what is referred to as a TNM TiAl alloy with niobium and molybdenum as alloy components, the change in the chemical composition in the region of the cylindrical-tube-shaped, tough layer 16 and its modified structure formation can be achieved by modified deposition conditions, such as a modified melting temperature of the powder material or a longer residence time of the electron beam in the corresponding regions in the respective stratum. As a result of the higher melting temperature or longer holding time of the melt at higher temperatures, evaporation of the more volatile aluminum occurs, and therefore the aluminum content of the TiAl alloy is reduced, giving rise to an alloy richer in titanium or a titanium alloy in the region of the tough layer 16, while the remaining component 15 outside the cylindrical-tube-shaped lattice structure of the tough layer 16 is formed from the intermetallic TiAl alloy with a higher aluminum content and lower toughness. The same result can be achieved if, during an aftertreatment, the deposited material is heated or remelted in the regions of the tough layer 16, thereby enabling aluminum to evaporate and its proportion of the material composition to be reduced.

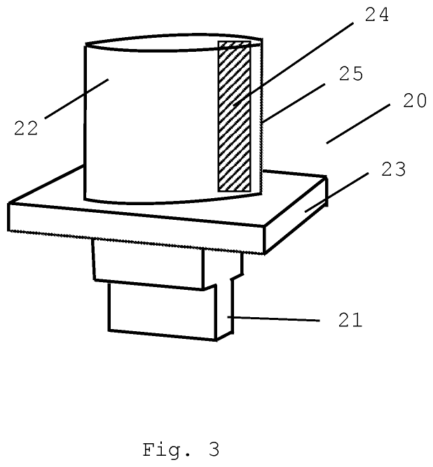

As a further exemplary embodiment, FIG. 3 shows a blade 20 of a turbomachine having a blade airfoil 22 and a blade root 21 as well as an inner shroud 23 arranged between the blade airfoil 22 and the blade root 21. The blade 20 is formed, for example, from a TiAl alloy containing 43.5 at. % Al, 4 at. % Nb, 1 at. % Mo and 0.1 at. % boron, the remainder being Ti and unavoidable impurities.

The blade 21 is formed additively from a powder material consisting of the TiAl alloy or a correspondingly adapted alloy, which allows an appropriate composition after production, or from a powder mixture of the elemental powders of the constituents of the alloy by selective electron beam melting, for example using a device shown in FIG. 1, wherein the blade 20 is formed in strata in accordance with the cross section of the blade 20 by melting and solidifying powder in corresponding strata on the part of the blade 20 which has already been produced.

In the vicinity of one of the blade edges 25, the toughness of the airfoil 22 is increased by providing a thin, tough layer 24, which is formed within the airfoil 22 in the vicinity of the airfoil surface, parallel to the blade edge 25. The cuboidal, tough layer 24 can be arranged, for example, at a distance of from about 100 μm to abour 1200 μm from the component surface and have a thickness of from about 200 μm to about 1500 μm in a direction perpendicular to the component surface. By appropriate evaporation of aluminum from the region of the tough layer 24 during deposition by means of modified deposition parameters and/or suitable aftertreatment in the region of the tough layer 24, for example by means of higher melting temperatures or a longer dwell time of the electron beam, the aluminum can evaporate down to fractions of about 10 at. %, thus ensuring that correspondingly less aluminum is contained in the region of the tough layer 24. For example, the titanium alloy formed in this way can have the following compositions in the region of the tough layer 24:

| Ti - alloy | at. % | at. % | at. % |
|---|---|---|---|
| Ti | 81.9 | 77.3 | 72.8 |
| Al | 10.0 | 15.0 | 20.0 |
| Nb | 6.4 | 6.0 | 5.7 |
| Mo | 1.6 | 1.5 | 1.4 |
| B | 0.2 | 0.2 | 0.1 |

As a result of the formation of a tough layer 24, the susceptibility of the blade 20 to crack formation, particularly in the case of impact stress in the region of the blade edges 25, can be reduced and thus the service life of a corresponding blade 20 can be increased.

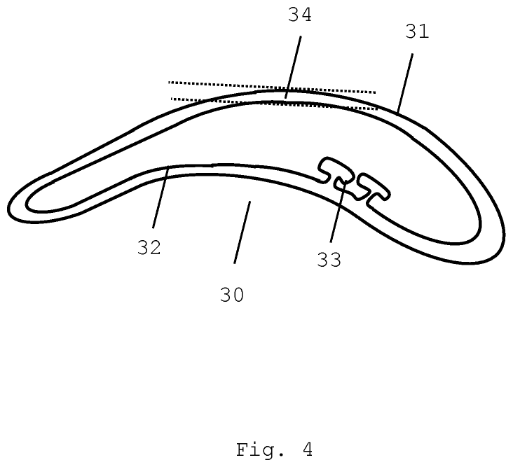

While in the exemplary embodiment in FIG. 3, the tough layer 24 is formed only in a part of the component 20 or only with respect to a part of the component surface, the cross section of FIG. 4 through the airfoil of a further blade 30 shows that a tough layer 32 can also be arranged circumferentially at a distance from the blade surface 31, at the edge of the cross section. The distance 34 of the tough layer 32 from the blade surface 31 is illustrated by the dashed lines which run perpendicularly to the surface normal of the corresponding surface region as a tangent to the surface or to the tough layer 32 and define the distance 34. In this exemplary embodiment too, the distance 34 can be in the range of from about 100 μm to about 1200 μm, and the distance can in general be measured from the component surface 31 to the boundary surface of the tough layer 32.

The cross section through the airfoil of the blade 30 also shows that the distance between the tough layer 32 and the component surface 31 can be varied and/or can form corresponding layer structures 33, as is shown by the hammer-shaped layer structures 33 of the tough layer 32. This enables the impact resistance and insensitivity of the blade 30 to impact stress to be increased further.

In the cross section shown, the layer structures 33 have a toothed profile which, in cross section, interlocks the regions located on both sides of the layer positively with one another. In the example shown, these regions are interlocked positively in all directions parallel to the section.

In other embodiments, the positive fit can also be parallel to the section only in a specific direction.

By means of the cross-sectional view of FIG. 4, it can also be made clear how a corresponding tough layer 32 can be produced in a simple manner in a generative or additive production process. In the case of generative production, the plane viewed in the illustration in FIG. 4 can also represent a stratum which is produced on the semifinished product. It is accordingly clear that in the region of the tough layer 32 the deposition conditions can be varied in a suitable manner in order to produce the tough layer 32, while in the remaining cross-sectional region of the blade 30 the deposition conditions are chosen in such a way that the blade material with the desired property profile, which has at least a lower toughness, is deposited. If the tough layer 32 is to be produced alternatively or additionally by aftertreatment, the electron beam can be guided over the cross section of the airfoil along the cross-sectional profile of the tough layer 32 to reheat or remelt the already deposited material, for example to evaporate aluminum, in order to produce the tough layer 32. In this way, simple and rapid production of a component with an internal tough layer for increasing the toughness and, in particular, impact resistance of the component is achieved.

To sum up, the present invention provides:
1. A method for producing an impact-resistant component, in particular a component of a turbomachine, such as an aircraft engine, wherein the component is produced at least partially by an additive manufacturing method from a powder material in such a way that the component is formed at least in a first region from a material with a first toughness and at least in a second region from a material with a second toughness, wherein the second toughness is greater than the first toughness, and wherein the second region is formed, at least in a part of the component, as a continuous or interrupted layer, preferably parallel to the surface of the component, at a distance from the surface of the component.
2. The method of item 1, wherein, in the additive manufacturing process, the component is built up in strata from powder material on a substrate or a previously produced part of the component and joined to form a solid component, wherein the method is selected, in particular, from selective laser melting, selective electron beam melting, selective laser sintering, selective electron beam sintering and powder deposition welding, wherein the layer has a closed annular profile in a section through the component, in particular perpendicularly to a build-up direction, and/or runs as a continuous line or as a broken line at a distance from the surface of the component, wherein the toughness of the material adjoining the layer on both or on a plurality of sides is less than the second toughness, in particular corresponds to the first toughness, and/or wherein, in a section through the component, in particular perpendicularly to a build-up direction, a section line of the layer separates two material regions of lower toughness, in particular the first toughness, from one another and has a toothed profile which interlocks the separated regions positively, in particular in all directions parallel to the section.
3. The method of any of the preceding items, wherein the material with the second toughness with a toughness different from the material with the first toughness is produced by a different additive deposition process, in particular by additive deposition with one or more different deposition parameters and/or by aftertreatment during additive deposition, in particular after the deposition of each stratum or of a plurality of strata, preferably with a high-energy beam, such as a laser beam or electron beam, in particular wherein, after the additive deposition of a stratum, the relevant stratum is treated again along a line contour with the high-energy beam to form a stratum of the layer.
4. The method of item 3, wherein the different deposition parameter or parameters during the additive deposition process comprises or comprise different melting or sintering temperatures and/or different holding times in the molten state or in the heated state and/or different ambient pressures.
5. The method of any of items 3 or 4, wherein the different deposition parameters of the powder material are selected in such a way that different amounts of constituents of the powder material evaporate.
6. The method of any of the preceding items, wherein the aftertreatment comprises reheating or remelting at least part of an already additively deposited stratum of the component, preferably in a width of from about 100 μm to about 2000 μm, in particular of from about 200 μm to about 1500 μm, and/or a depth of at least one stratum thickness, in particular certain constituents being evaporated.
7. The method of any of the preceding items, wherein the powder material used for additive deposition is a powder of a TiAl alloy and/or a mixture of powders of the individual elements for forming a TiAl alloy, in particular a TiAl alloy which comprises from about 43.5 at. % to about 48 at. % Al, from about 4 at. % to about 6 at. % Nb and, of the alloy elements Mo, W, Zr, Si, C and B, in total up to about 2 at. %, the remainder being Ti and unavoidable impurities, preferably about 43.5 at. % Al, about 4 at. % Nb, about 1 at. % Mo and about 0.1 at. % boron, the remainder being Ti and unavoidable impurities.
8. The method of any of the preceding items, wherein, after additive manufacture, the component is subjected to a heat treatment in order to adjust the structures of the material with the first toughness and of the material with the second toughness.
9. An impact-resistant component, in particular produced by an additive manufacturing method and/or a blade for a turbomachine, in particular an aircraft engine, preferably as recited in any of the preceding items, wherein the component has at least one first region of a material with a first toughness and at least one second region of a material with a second toughness, wherein the second toughness is greater than the first toughness, and wherein the second region is designed at least in a part of the component as a continuous or interrupted layer at a distance from the surface of the component.
10. The component of item 9, wherein the second region runs parallel to the surface of the component, at least in a part of the component, wherein the layer has a closed annular profile in a section through the component, in particular perpendicularly to a build-up direction, and/or runs as a continuous line or as a broken line at a distance from the surface of the component, wherein the toughness of the material adjoining the layer on both or on a plurality of sides is less than the second toughness, in particular corresponds to the first toughness, and/or wherein, in a section through the component, in particular perpendicularly to a build-up direction, a section line of the layer separates two material regions of lower toughness, in particular the first toughness, from one another and has a toothed profile which interlocks the separated regions positively, in particular in all directions parallel to the section.
11. The component of item 9 or 10, wherein the material with the second toughness differs from the material with the first toughness in having a different chemical composition and/or a different microstructure.
12. The component of any of items 9 to 11, wherein the interrupted layer has a mesh or lattice structure.
13. The component of any of items 9 to 12, wherein the layer of the material with a second toughness is located from about 100 μm to about 1200 μm, in particular from about 200 μm to about 500 μm, below the component surface and/or the layer of the material with a second toughness has a layer thickness of from about 100 μm to about 2000 μm, in particular of from about 200 μm to about 1500 μm, extending in the direction perpendicular to the component surface.
14. The component of any of items 9 to 13, wherein the material with the first toughness is a TiAl alloy, in particular a TiAl alloy containing about 43.5 at. % Al, about 4 at. % Nb, about 1 at. % Mo and about 0.1 at. % boron, the remainder being Ti and unavoidable impurities, and the material with the second toughness is a material with a reduced aluminum content compared with the material with the first toughness, in particular a Ti alloy containing from about 10 at. % to about 20 at. % Al, from about 5.7 at. % to about 6.4 at. % Nb, from about 1.4 at. % to about 1.6 at. % Mo and from about 0.1 at. % to about 0.2 at. % boron, the remainder being Ti and unavoidable impurities, preferably a Ti alloy containing about 10 at. % Al, about 6.4 at. % Nb, about 1.6 at. % Mo and about 0.2 at. % boron, the remainder being Ti and unavoidable impurities.
15. The component of item 14, wherein the material with the first toughness is built up with an intermetallic TiAl structure with γ-TiAl and α₂-Ti₃Al and the material with the second toughness is built up with a microstructure of a Ti alloy based on an α phase, a β phase and/or an ω phase.

Although the present invention has been described in detail with reference to the exemplary embodiments, it is self-evident to a person skilled in the art that the invention is not restricted to these exemplary embodiments but that, on the contrary, modifications are possible in such a way that individual features can be omitted or different combinations of features can be implemented without exceeding the scope of protection of the appended claims. In particular, the present disclosure includes all combinations of the individual features shown in the various exemplary embodiments, and therefore individual features which are described only in connection with one exemplary embodiment can also be used in other exemplary embodiments or combinations of individual features which are not explicitly described.

### LIST OF REFERENCE SIGNS

1 device
2 lifting table
3 semifinished product or manufactured component
4 electron source
5 electron beam
6 powder bed
7 support table
8 slide
9 lifting table
10 powder
11 housing
15 cylindrical component
16 cylindrical-tube-shaped tough layer
20 blade
21 blade root
22 airfoil
23 shroud
24 tough layer
25 blade edge
30 blade
31 blade surface
32 tough layer
33 layer structure
34 distance of the tough layer from the component surface

What is claimed is:

1. A method for producing an impact-resistant component, wherein the component is produced at least partially by an additive manufacturing method from a powder material in such a way that the component is formed at least in a first region from a material with a first toughness and at least in a second region from a material with a second toughness, the second toughness being greater than the first toughness, and wherein the second region is formed, at least in a part of the component, as a continuous or interrupted layer at a distance from a surface of the component.

2. The method of claim 1, wherein, in the additive manufacturing process, the component is built up in strata from powder material on a substrate or a previously produced part of the component and joined to form a solid component, wherein the layer has a closed annular profile in a section through the component and/or runs as a continuous line or as a broken line at a distance from the surface of the component, a toughness of a material adjoining the layer on both or on a plurality of sides being less than the second toughness, and/or wherein, in a section through the component a section line of the layer separates two material regions of lower toughness from one another and has a toothed profile which interlocks the separated regions positively.

3. The method of claim 1, wherein the material with the second toughness is produced by a different additive deposition process than the material with the first toughness.

4. The method of claim 3, wherein the material with the second toughness is produced by additive deposition with one or more different deposition parameters than the material with the first toughness and/or by aftertreatment during additive deposition.

5. The method of claim 4, wherein the different deposition parameter or parameters comprises or comprise different melting or sintering temperatures and/or different holding times in the molten state and/or different ambient pressures.

6. The method of claim 4, wherein the different deposition parameters of the powder material are selected in such a way that different amounts of constituents of the powder material evaporate.

7. The method of claim 4, wherein the aftertreatment comprises reheating or remelting at least part of an already additively deposited stratum of the component.

8. The method of claim 1, wherein the powder material used for additive deposition is a powder of a TiAl alloy and/or a mixture of powders of individual elements for forming a TiAl alloy.

9. The method of claim 8, wherein the TiAl alloy comprises from 43.5 at. % to 48 at. % Al, from 4 at. % to 6 at. % Nb and, of the alloy elements Mo, W, Zr, Si, C and B, in total up to 2 at. %, the remainder being Ti and unavoidable impurities.

10. The method of claim 1, wherein after additive manufacture, the component is subjected to a heat treatment in order to adjust structures of the material with the first toughness and of the material with the second toughness.

11. An impact-resistant component, wherein the component has at least one first region of a material with a first toughness and at least one second region of a material with a second toughness, the second toughness being greater than the first toughness, and wherein the at least one second region is designed at least in a part of the component as a continuous or interrupted layer at a distance from a surface of the component.

12. The component of claim 11, wherein the second region runs parallel to the surface of the component at least in a part of the component, and wherein the layer has a closed annular profile in a section through the component and/or runs as a continuous line or as a broken line at a distance from the surface of the component.

13. The component of claim 12, wherein a toughness of the material adjoining the layer on both or on a plurality of sides is lower than the second toughness, and wherein, in a section through the component a section line of the layer separates two material regions of lower toughness from one another and has a toothed profile which interlocks the separated regions positively.

14. The component of claim 11, wherein the material with the second toughness differs from the material with the first toughness in having a different chemical composition and/or a different microstructure.

15. The component of claim 11, wherein the interrupted layer has a mesh or lattice structure.

16. The component of claim 11, wherein the layer of the material with the second toughness is located from 100 μm to 1200 μm below the component surface and/or the layer of the material with the second toughness has a layer thickness of from 100 μm to 2000 μm, extending in a direction perpendicular to the component surface.

17. The component of claim 11, wherein the material with the first toughness is a TiAl alloy and the material with the second toughness is a material with a reduced aluminum content compared with the material with the first toughness.

18. The component of claim 11, wherein the material with the first toughness is a TiAl alloy comprising about 43.5 at. % Al, about 4 at. % Nb, about 1 at. % Mo and about 0.1 at. % boron, the remainder being Ti and unavoidable impurities, and the material with the second toughness is a Ti alloy comprising from 10 at. % to 20 at. % Al, from 5.7 at. % to 6.4 at. % Nb, from 1.4 at. % to. 6 at. % Mo and from 0.1 at. % to 0.2 at. % boron, the remainder being Ti and unavoidable impurities.

19. The component of claim 18, wherein the material with the second toughness is a Ti alloy comprising about 10 at. % Al, about 6.4 at. % Nb, about 1.6 at. % Mo and about 0.2 at. % boron, the remainder being Ti and unavoidable impurities.

20. The component of claim 11, wherein the material with the first toughness is built up with an intermetallic TiAl structure with γ-TiAl and α₂-Ti₃Al and the material with the second toughness is built up with a microstructure of a Ti alloy based on an α phase, a β phase and/or an ω phase.
